(19) United States
(12) Patent Application Publication
(10) Pub. No.: US 2009/0112639 A1
(43) Pub. Date: Apr. 30, 2009

(54) Combined Rewards System and Process Providing Variable Travel Redemption

(76) Inventor: Nancy J. Robinson Beaver, Clayton, CA (US)

Correspondence Address: FOLEY & LARDNER, 777 EAST WISCONSIN AVENUE, SUITE 3800, MILWAUKEE, WI, 53202-5306, US

(21) Appl. No.: 11/930,921

(22) Filed: Oct. 31, 2007

(51) Int. Cl. G06Q 30/00; G06Q 10/00; G06Q 40/00

(52) U.S. Cl. 705/5; 705/14; 705/39; 705/26

(57) ABSTRACT

A loyalty rewards system and process rewards currency, e.g. cash back rebates or rewards points, for credit card and check card purchases and provides rewards, including travel, for a customer's enterprise relationship. The system and process include methodologies for: enrollment into the combined rewards program or the relationship rewards program; showing total combined points or cash earned with points or amount of cash earned parsed into the various accounts and purchases. Customers are informed of currency earned via periodic statements, newsletters, data online and customer service representatives. A mechanism by which to systematically enroll eligible products or services as defined by the enterprise bases eligibility on social security numbers or other unique customer numbers. A variable travel rewards program eliminates the usual restrictions on reward travel, allowing participants to travel anywhere at any time, to combine points with cash to pay for travel and to book their own travel.

### BACKGROUND OF THE INVENTION

1. Technical Field

The invention relates to computer-implemented incentive programs. More particularly, the invention relates to a combined rewards system and process that provides variable travel reward redemption.

2. Description of Related Technology

Many individuals hold credit cards and check cards. At the same time, some enterprise credit card and check card programs offer reward-based programs as incentive for a target cardholder to use the card associated with the program. An individual often carries different cards to participate in a variety of different reward programs. A typical reward program awards points based upon the amount and/or type of purchases made with the card. Thus, depending on the purchase, an individual may select the card with the greatest reward opportunity associated with that particular purchase.

Banco Popular of Popular, Inc., provides a rewards program called Premia® under personal banking, a description of which is provided on the Banco Popular web site. Banco Popular mentions customers can receive points for certain activities but a deposit account or a credit card account with Banco Popular is required. For communicating earned rewards points to its customers, Banco Popular only offers issued statements on a quarterly basis

One issuer, Marshall & Ilsley Corporation (M&I Bank), has a combined rewards program that awards points for credit and check card spending. However, there are disadvantages of this program, as follows:
The credit card statement shows points earned on the credit card and the checking statement shows points earned on the check card. The showing of points earned is not combined into one statement.
A customer can view a combined points statement online and can call customer service for the same information. However, the rewards points are not parsed and displayed by credit card and check card.
The two cards combined have to share the same primary social security number.

To date, there is no program that offers a combined cash rewards or a relationship rewards program.

Participants in reward programs are sometimes frustrated by the restrictions they encounter when redeeming their points for travel rewards. For example, card issuers and reward program administrators often impose restrictions on the type of air travel that a program participant can book using the participant's points or they require that the redemptions be made through a specific vendor. It is a common practice to impose blackout dates-heavy travel dates such as holidays when rewards travel is severely restricted. Often there are advance purchase requirements and minimum stay requirements. While card issuers have imposed such restrictions partially as a way to control the cost of travel rewards programs, heretofore, the technology has not been available to implement and maintain programs that provided variable travel rewards.

Additionally, some programs impose static redemption levels for reward travel. For example, one program requires the participant to redeem fifteen thousand points for any ticket having a face value of up to $150.00 and thirty-five thousand points for tickets costing between $150.01 and $350.00 and so on. Thus, a fixed redemption scheme such as this penalizes those purchasing tickets at the low end of a range, effectively making their lower-priced ticket more expensive for the distance traveled than a ticket at the high end of the range.

Moreover, reward programs have not allowed a participant to combine points with cash for reward travel. For example, if a ticket cost fifty thousand points, the redeemer had to have fifty thousand points to redeem. Programs would not allow someone having only forty thousand points, for example, to make up the shortfall in cash.

Such restrictions have lead to great frustration among program participants and card issuers and program administrators alike. Restricted travel rewards are of limited value to the traveling public. Additionally, because restrictions on reward travel make a program less attractive to participants, the program is also less effective at ensuring customer loyalty.

### SUMMARY OF THE INVENTION

A loyalty rewards system and process rewards currency, e.g. cash back rebates or rewards points, for credit card and check card purchases and provides rewards, including travel, for a customer's enterprise relationship. The system and process include methodologies for: enrollment into the combined rewards program or the relationship rewards program; showing total combined points or cash earned with points or amount of cash earned parsed into the various accounts and purchases. Customers are informed of currency earned via periodic statements, newsletters, data online and customer service representatives. A mechanism by which to systematically enroll eligible products or services as defined by the enterprise bases eligibility on social security numbers or other unique customer numbers. A variable travel rewards program eliminates the usual restrictions on reward travel, allowing participants to travel anywhere at any time, to combine points with cash to pay for travel and to book their own travel.

### BRIEF DESCRIPTION OF THE DRAWINGS

FIG. 1 is a flow diagram of a combined relationship rewards method;

FIG. 2 is a flow diagram of combined cash back rewards method;

FIG. 3 is a schematic diagram of a system architecture;

FIG. 4 is a flow diagram of an embodiment of the combined rewards process;

FIG. 5 is a flow diagram of an embodiment of the relationship rewards process;

FIG. 6 provides a view of a customer account screen of a user interface to a network-based reward program application;

FIG. 7 provides a view of a screen listing available rewards from the user interface of FIG. 6;

FIG. 8 provides a view of a screen showing details of a travel reward from the user interface of FIG. 6;

FIG. 9 provides a view of a ‘view cart’ page from the user interface of FIG. 6;

FIG. 10 provides a view of a ‘Check out’ page from the user interface of FIG. 6;

FIG. 11 provides a view of an order history page from the user interface of FIG. 6; and

FIG. 12 provides a view of a ‘My Trip’ screen from the user interface of FIG. 6.

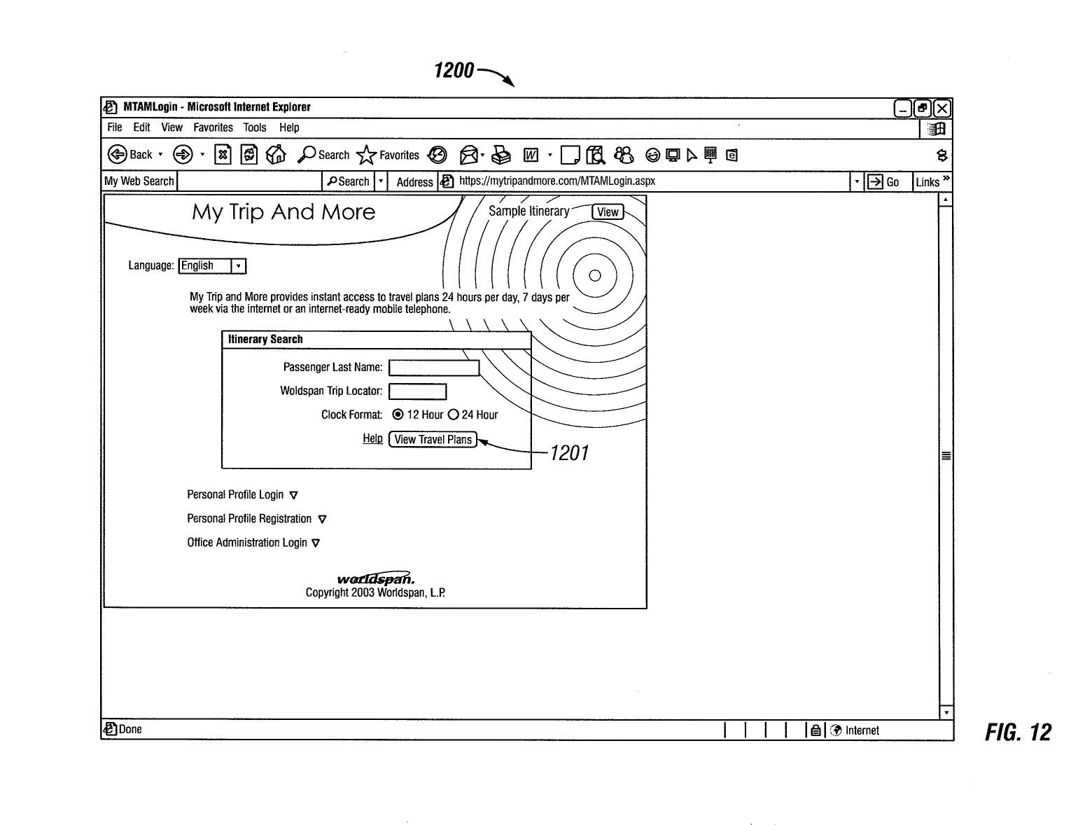

### DETAILED DESCRIPTION

A loyalty rewards system and process rewards currency, e.g. cash back rebates or rewards points, for credit card and check card purchases and provides rewards, including travel, for a customer's enterprise relationship. The system and process include methodologies for: enrollment into the combined rewards program or the relationship rewards program; showing total combined points or cash earned with points or amount of cash earned parsed into the various accounts and purchases. Customers are informed of currency earned via periodic statements, newsletters, data online and customer service representatives. A mechanism by which to systematically enroll eligible products or services as defined by the enterprise bases eligibility on social security numbers or other unique customer numbers. A variable travel rewards program eliminates the usual restrictions on reward travel, allowing participants to travel anywhere at any time, to combine points with cash to pay for travel and to book their own travel.

### Acquisition and Usage

One embodiment of the invention provides a unique rewards program where customers can earn points for acquisition, balances, and usage of multiple products and services. One example application is a financial institution with products including credit cards, direct deposit accounts (DDA), check cards, mortgages, investments, home equity, etc. This concept can be applied to any industry, such as for example insurance or health, where the customer can own multiple products. However, describing the invention herein in terms of the financial institution and the products listed hereinabove are by way of example only and are not meant to be limiting. In one embodiment of the invention, a financial institution has an internal system of record (SOR) that contains the information about what products a customer owns and uses and the corresponding activity. Rewards currency is assigned to each product and activity. For example, one point is assigned for every $1 of credit card spending and one point is assigned for every $100 in a mortgage balance. The financial institution houses this point information and can provide a total amount as well as an itemized list of amount of points. Thus, points earned on all products are combined into one program and are redeemable for a wide variety of rewards choices ranging from travel to retail to cash redemption options. The invention enables a customer to view points frequently, parsed by product, e.g. split out by credit card and check card, via a monthly credit card statement and online. Hence, the invention allows an enterprise to know its customer and reward the customer for the customer's entire relationship with the enterprise.

### Unique Customer Number

In one embodiment of the invention, a unique customer number is used to identify and link together products owned by a customer, thereby enabling the awarding of rewards currency, e.g. points and cash back, based on customer ownership and usage of multiple products.

### Systematic Enrollment

One embodiment of the invention targets and fulfills enrollment by identifying eligible cardholders with other products or services, such as check cards for example, identifying the corresponding account numbers, and systematically enrolling such card holder and account numbers. For example, the process may start with identifying the credit cardholder, identifying any check cards owned by either the primary or secondary credit cardholder, and systematically enrolling the check card accounts found. The enrollment process is then configured so that the check card points are combined with the credit card points. Thus, by providing a mechanism that systematically enrolls multiple check card accounts belonging to the primary or secondary credit cardholder, the customer greatly benefits due to such an escalated process for earning points.

One embodiment of the invention offers a combined cash back rebate for product purchases, such as credit card and/or check card purchases, where the total combined spent from all cards are included. The amount of rebate earned can be determined by the enterprise. For example, in one embodiment of the invention, the enterprise determines the amount of rebate based on a monthly tiering process. For example, wherein the first $100 earns 0.50%, the next $200 earns 0.75% and any additional spend earns 1% for that month. A different rebate amount is applied based on amount spent per month, and is reset each month, not on an annual basis. The rebate can also be earned for ownership and/or for usage of additional bank products.

One embodiment of the invention offers combined points for purchases and the like. As an example, the enterprise can offer enrollees a reward program whereby one (1) point is earned per credit card dollar spent, such as per $1.00 credit card spent, and one (1) point is earned per offline check card spent, such as per $4.00 offline check card spent. Also, different schemes can be offered to different target customers. By way of example, one particular program can be offered to students, secured accounts, and low-line unsecured accounts and can be offered for a reduced annual program fee. Points are combined and eligible for a variety of redemption options.

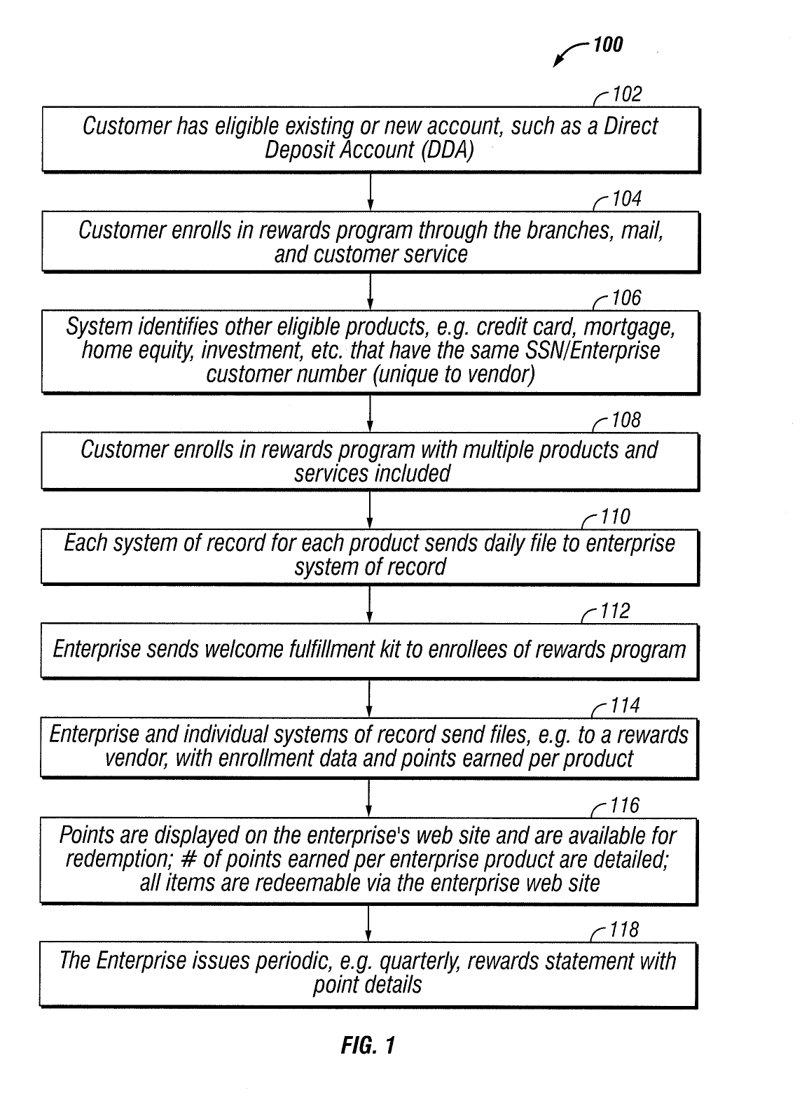

One embodiment of the invention can be described with respect to FIG. 1, a flow diagram of a combined relationship rewards method according to the invention (100). A customer has an eligible existing or new account, such as a Direct Deposit Account (102). The customer enrolls in the rewards program through entities such as for example branches, mail, and customer service (104). Then the system identifies other eligible products, e.g. credit card, mortgage, home equity, investment, etc., that have the same primary key, such as the customer's social security number (SSN) or the customer's enterprise customer number, which is unique to the enterprise (106), etc.

### One Enrollment

Then, the system, having identified each eligible product, enrolls the customer in the rewards program with multiple products or services included (108). As part of ongoing processing, each system of record for each product sends a periodic, e.g. daily, file feed to the enterprise system of record (110). The system tracks the points earned per product and combines the points for a total amount. Such information is fed to various other internal or external, e.g. FDR and rewards vendor systems, such that customers can be provided with a points summary which provides details on how the points were earned by product.

In one embodiment of the invention, after the enrollment is completed, the enterprise sends a welcome fulfillment kit to enrollees of the rewards program (112), confirming enrollment and outlining benefits of the program. The enterprise and individual systems of record send files with enrollment data and points earned per product for processing, e.g. to a rewards vendor so the customer can view activity and points earned per product.

In one embodiment of the invention, two daily files are sent to the vendor. One file contains customer information such as name and address, in case there are any changes and the other file contains the number of points earned (114). The points earned and total points processed are displayed and are available for redemption on the enterprise's web site, on a statement, and via a customer service representative. The number of points earned per enterprise product is detailed (116). In one embodiment of the invention, all items are redeemable via the enterprise web site. The enterprise issues a periodic, e.g. quarterly rewards statement with point details (118).

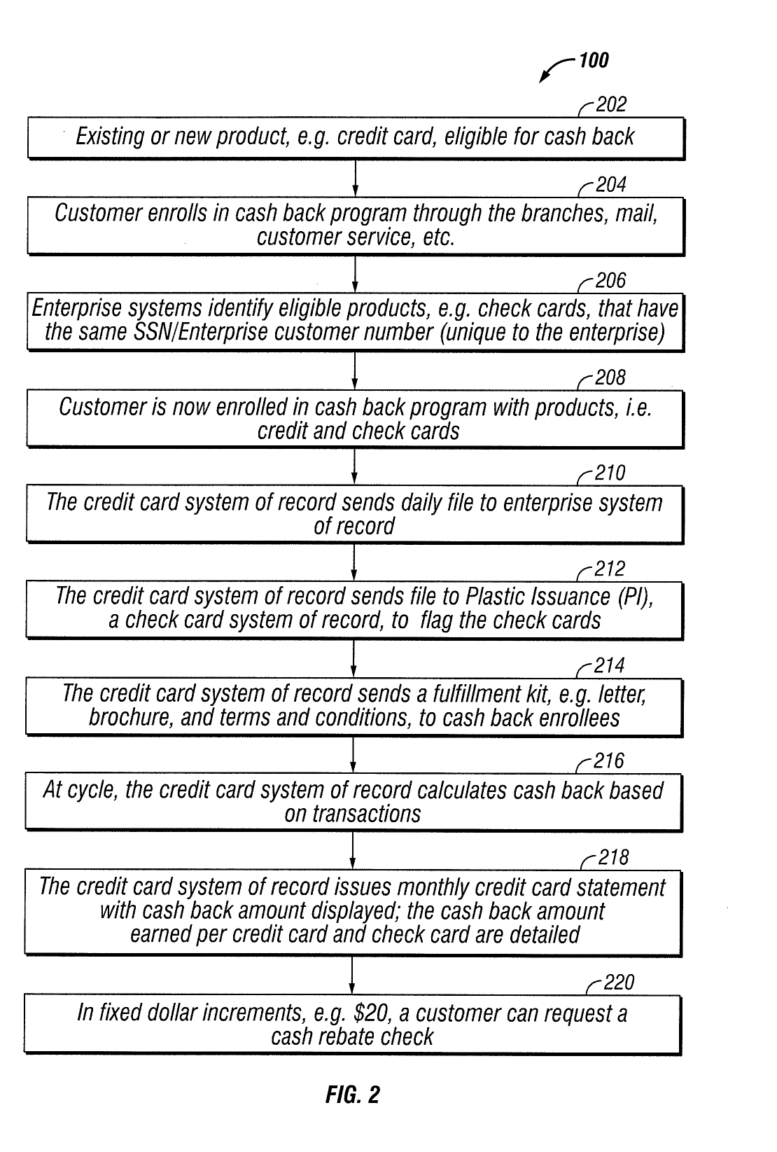

An alternate embodiment of the invention can be described with respect to FIG. 2, a flow diagram of a combined cash back rewards method according to the invention (200). An existing or new product, e.g. credit card, is eligible for cash back (202). The customer enrolls in the cash back program through mechanisms such as for example online, branches, mail, and customer service (204). The enterprise system identifies other eligible products, e.g. check cards that have the same SSN and/or an enterprise customer number, which is unique to the enterprise (206). The customer is systematically enrolled in the cash back program with products, e.g. credit and check cards (208). For ongoing processing, the credit card system of record sends a periodic, e.g. daily, file feed to the enterprise system of record (210). The credit card system of record sends a second file feed to a check card system of record to flag the check cards that are part of the combined enrollment for earning points (212). After the enrollment process, the credit card system of record sends a fulfillment kit containing, for example, letters, brochures, and terms and conditions, to cash back enrollees (214). In one embodiment of the invention, the credit card SOR performs such functionality; however this is by way of example only and is not meant to be limited to the credit card SOR. The credit card system of record calculates a cash back amount based on the customer's transactions (216). The credit card system of record issues a credit card statement, such as monthly, with the cash back amount displayed. The cash back amounts earned per credit card and the cash back amounts earner per check card are shown individually (218). In one embodiment of the invention, the customer can request a cash back rebate check or statement credit. In another embodiment of the invention, the amount of rebate is in fixed dollar increments, such as in $20.00 increments (220).

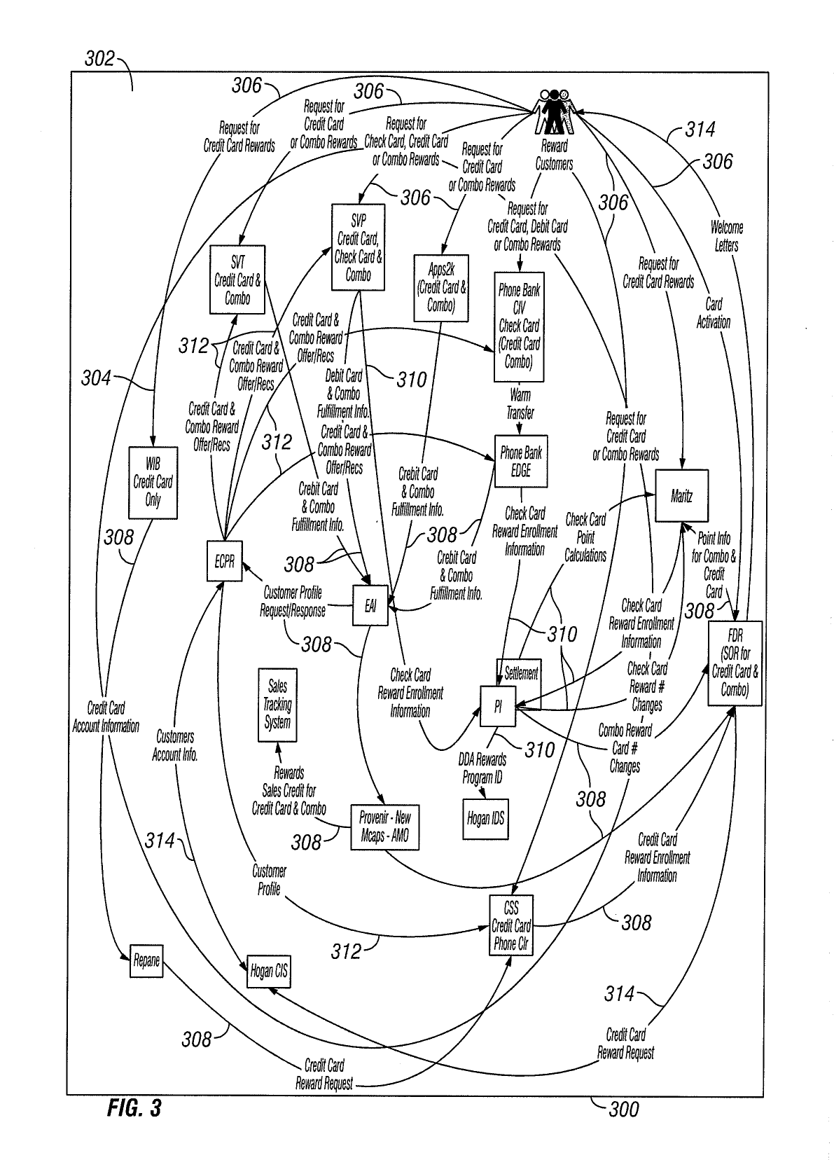

One embodiment of the invention can be described with reference to FIG. 3, a schematic diagram of system architecture of the combined rewards program 300. FIG. 3 shows the various internal systems of an exemplary financial institution 304 and example systems outside the institution 302. Reward customers (client servers or by phone and the like) make requests for enrolling into the combined rewards program 306. The enrollment requests 306 have several entry points inside and outside the enterprise. The enrollment process includes checking other system SORs both internal and external for other accounts and/or products used and owned by the customer. The checking is performed using a proprietary and unique number, such as a social security number or unique enterprise customer number. In response to the enrollment requests, some internal and external systems perform fulfillment activities 308. In this example, credit card SORs perform combined rewards fulfillment 308. Also, in response to the enrollment requests, some internal and external systems or vendors perform fulfillment activities from check card SORs 310. An internal system, ECPR in this example, provides rewards recommendation and offers based on a customer's profile 312. Depending on the channel of enrollment, such as online, branches, and mail, etc., the enrollment may be fulfilled and processed by different internal systems, e.g. Provenir, Reparte, and EAI, etc. Also, systems may vary depending on which products or services are included. In this example, ECPR stands for Enterprise Customer Profiling and Referral and is a database of customer information or profiles. It can also be referred to as an offers database. Other system activity is carried out in parallel 314.

### An Example Combined Rewards Implementation

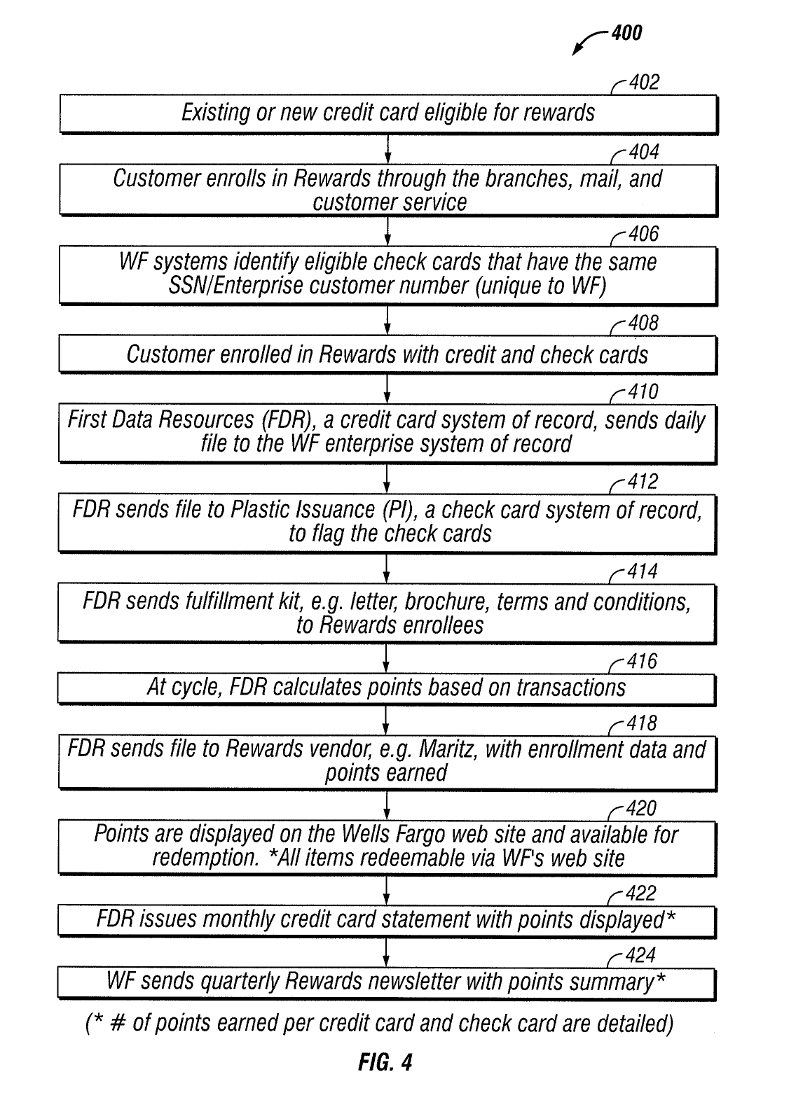

An example implementation by Wells Fargo can be described with reference to FIG. 4, a flow diagram of an embodiment of a combined rewards process (400) according to the invention. Existing or new credit card eligible for rewards is available to a customer (402). The customer enrolls in the combined rewards program through the branches, mail, and customer service, etc. (404). Wells Fargo (WF) systems identify eligible check cards that have the same SSN/Enterprise Customer Number (unique to WF) (406). The customer is formally enrolled in the rewards program with credit and check cards as products (408). The First Data Resources credit card system of record (FDR) sends a daily file to WF's enterprise system of record (410). FDR also sends a file to Plastic Issuance, a check card system of record, to flag the check cards (412). In addition, FDR sends a fulfillment kit, including a letter, brochure, terms and conditions, etc., to rewards program enrollees (414). FDR calculates points based on transactions (416). FDR sends a file to a rewards vendor, e.g. Maritz, with enrollment data and points earned (418). Points can be displayed on the Wells Fargo or vendor's web site, where the points are also available for redemption (420); the number of points earned per credit card and check card are detailed. All items that are redeemable are available via the Wells Fargo web site (420). FDR issues monthly credit card statement with points displayed; the number of points earned per credit card and check card are detailed (422). WF sends a quarterly rewards newsletter with points summary and where the number of points earned per credit card and check card are detailed (424).

### An Example Relationship Rewards Implementation

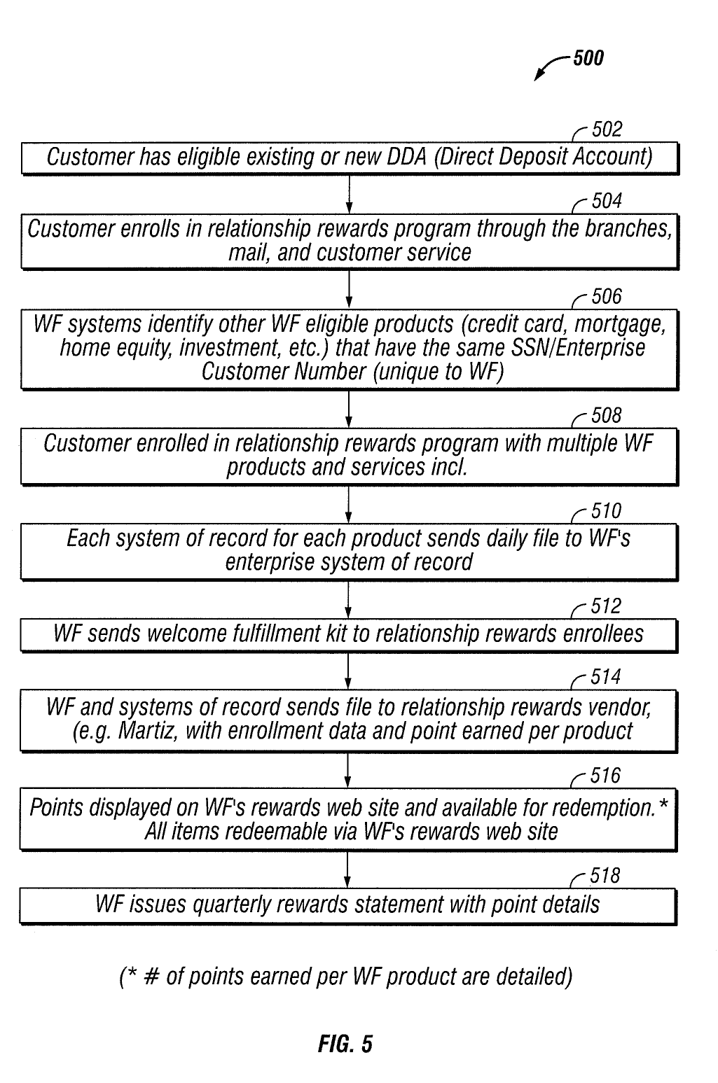

An example implementation by Wells Fargo can be described with reference to FIG. 5, a flow diagram of an embodiment of a relationship rewards process (500) according to the invention. A customer has an eligible existing or new Direct Deposit Account (DDA) (502). The customer enrolls in the relationship rewards program through the branches, mail, and customer service (504). Wells Fargo (WF) systems identify other WF eligible products, such as for example, credit card, mortgage, home equity, investment, etc., that have the same SSN/Enterprise customer number (unique to WF) (506). The customer gets enrolled in the relationship rewards with multiple WF products included (508). Each system of record for each product sends a daily file to the Wells Fargo enterprise system of record (510). Wells Fargo sends a welcome fulfillment kit to the relationship rewards enrollees (512). Wells Fargo sends files to a relationship rewards vendor, e.g. Maritz, with enrollment data and points earned per product (514). Points are displayed on the Wells Fargo web site and are available for redemption; the number of points earned per WF product is detailed (516). All items are redeemable via the Wells Fargo web site (516). Wells Fargo issues a quarterly relationship rewards statement with point details (518).

The foregoing system also provides a method and infrastructure for rewards program participants to redeem rewards. In particular, the rewards redemption aspect of the system provides for variable travel redemption wherein program participants may redeem rewards points for restricted or unrestricted air travel. For air travel redemption, the rewards program assigns a monetary value to each point awarded to a participant. In one embodiment, the cash value of each point is established as $0.015; however this amount is merely exemplary. Thus, the points substantially become a cash equivalent.

Using the points as cash, the rewards program allows the participant to purchase substantially any itinerary on any air carrier for any destination in any class. Additionally, the rewards program allows the participant to combine points with actual cash, thus lending the travel reward program an even greater degree of flexibility. The participant who therefore lacks sufficient points to pay for his or her selected itinerary can still redeem the points toward the itinerary, making up the remainder of the ticket price with cash. In one embodiment of the invention, the cash portion of the ticket purchase is automatically subtracted from one of the associated accounts.

In another embodiment, program participants book their own travel completely free of restrictions and pay for the travel with their credit cards. Subsequently, the program participants are permitted to redeem points as payment on the credit card balance incurred by booking the travel on the credit. In other words, the relationship rewards vendor reimburses program participants for the travel cost by allowing them to apply points toward their credit card balances. In this way, the program participant is allowed complete freedom to book his own travel, air travel, for example, from the vendor of his choice, without any of the restrictions that are conventionally associated with reward travel programs.

In one embodiment, the relationship rewards vendor locates the itinerary for the participant and makes all of the purchase arrangements. The required number of points is then deducted from the participant's accrued point total. For example, the participant may tell the rewards vendor that they would like a round-trip business class ticket between New York and Paris, on UNITED AIRLINES (UAL, INC., Chicago Ill.), for example, at a specific time of day. The relationship rewards vendor locates the ticket, using, for example, an online airfare pricing and shopping system. The rewards vendor then tickets the itinerary, also using an online ticketing system. The rewards vendor then reports the price of the ticket to the participant and subtracts the required points and/or cash from the participant's account. For example, a ticket for the above itinerary may cost, for example, $3299.00. The number of points required to purchase the ticket would be 219,933 (3299/0.015). If the participant has adequate points, the total amount may be deducted from the participant's accrued points. Alternatively, the participant may use a combination of points and cash, with the cash amount being debited from a credit card enrolled in the rewards program, for example.

The foregoing description of a redemption transaction is merely exemplary. Other embodiments are possible. For example, steps of the transaction may occur in a different sequence, or the transaction may involve more or fewer steps. In one embodiment, the participant may locate the itinerary and do the ticketing without using the rewards vendor as an intermediary.

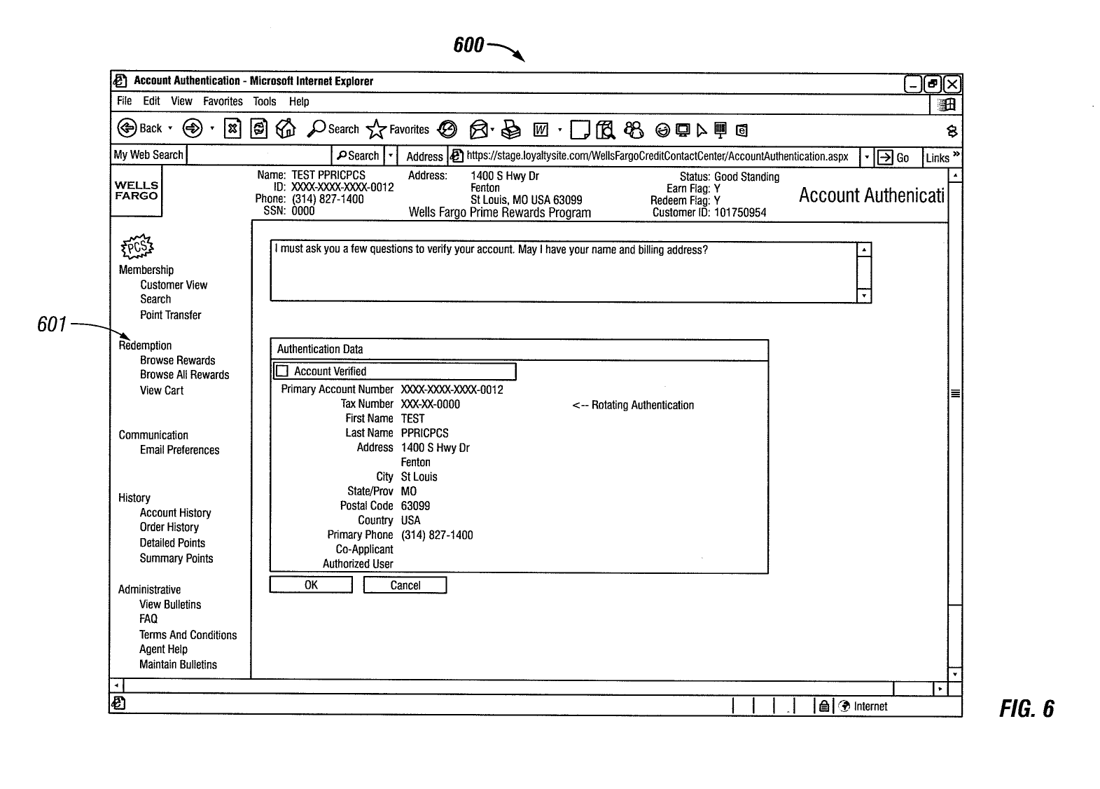

FIG. 6 shows a customer account screen 600 from a user interface to a network-based shopping cart application by which the participant interacts with the program vendor in redeeming points for rewards. Over a network connection, the application and user interface enables a chat- or IM-type of interaction between the participant and the vendor, wherein the participant reads messages sent by the vendor in a box 601 and provides the necessary information in response by using the various data entry tools provided in the user interface.

Initially, the participant is authenticated by being requested to provide account information 602. Once the account is verified, the participant is allowed to select from a menu of options 603, organized by category. Among these options is ‘Browse rewards’ 604. Selecting ‘Browse rewards’ navigates the participant to a screen that allows them to view available rewards, particularly travel offers.

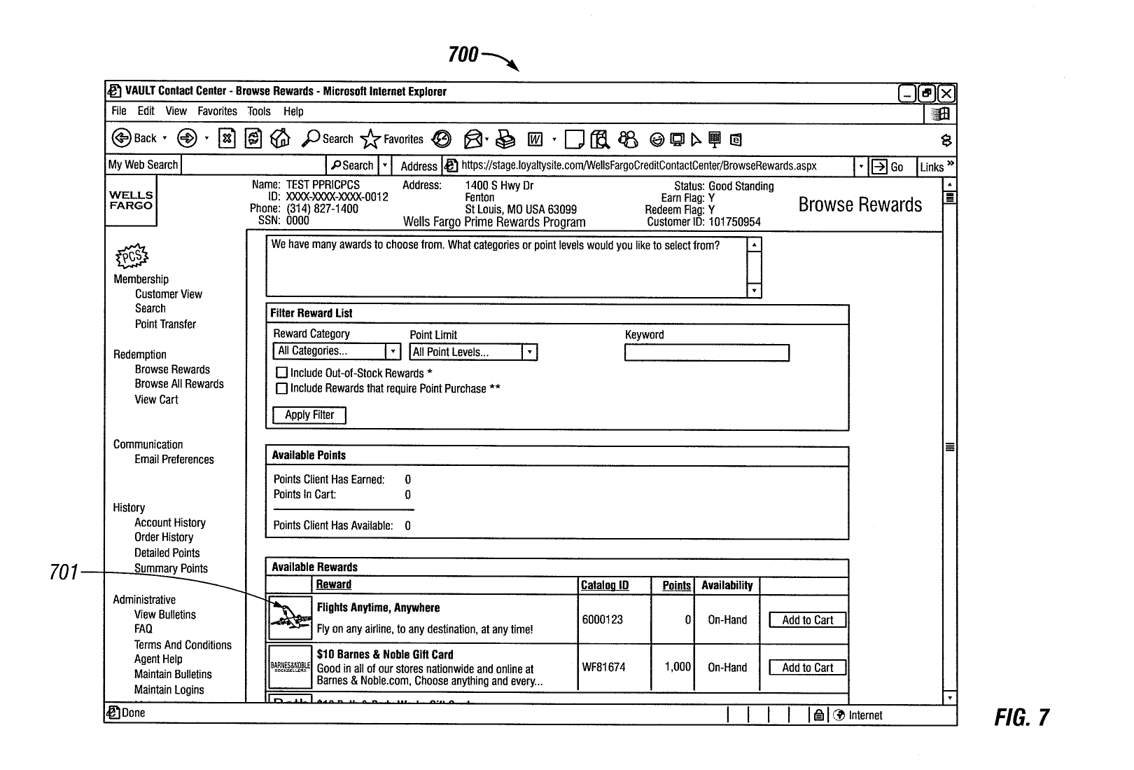

FIG. 7 provides a view of a screen 700 listing available rewards. Under ‘Available rewards,’ a listing of rewards is displayed. In order to select a travel reward, the participant selects the icon ‘Flights Anytime, Anywhere’ 701 in order to access a detailed description of the item.

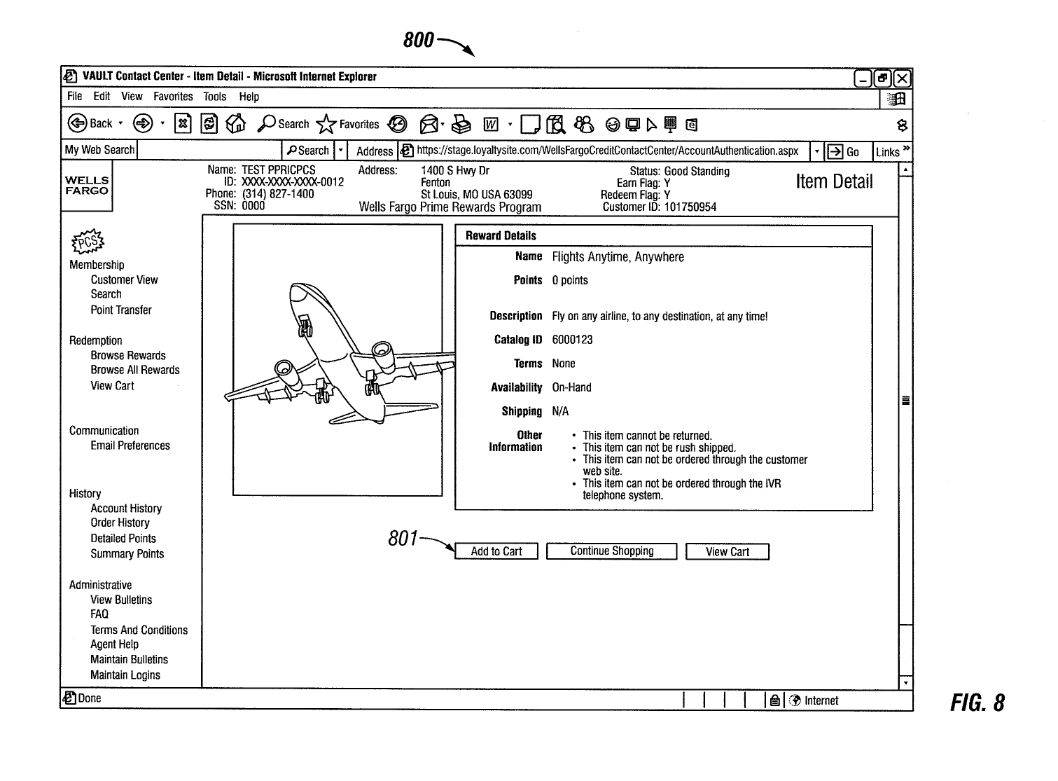

FIG. 8 provides a view of a screen 800 showing details of a travel reward. In order to select the travel reward, the participant selects the ‘Add to Cart’ control 801, whereupon the travel reward is added to the participant's shopping cart.

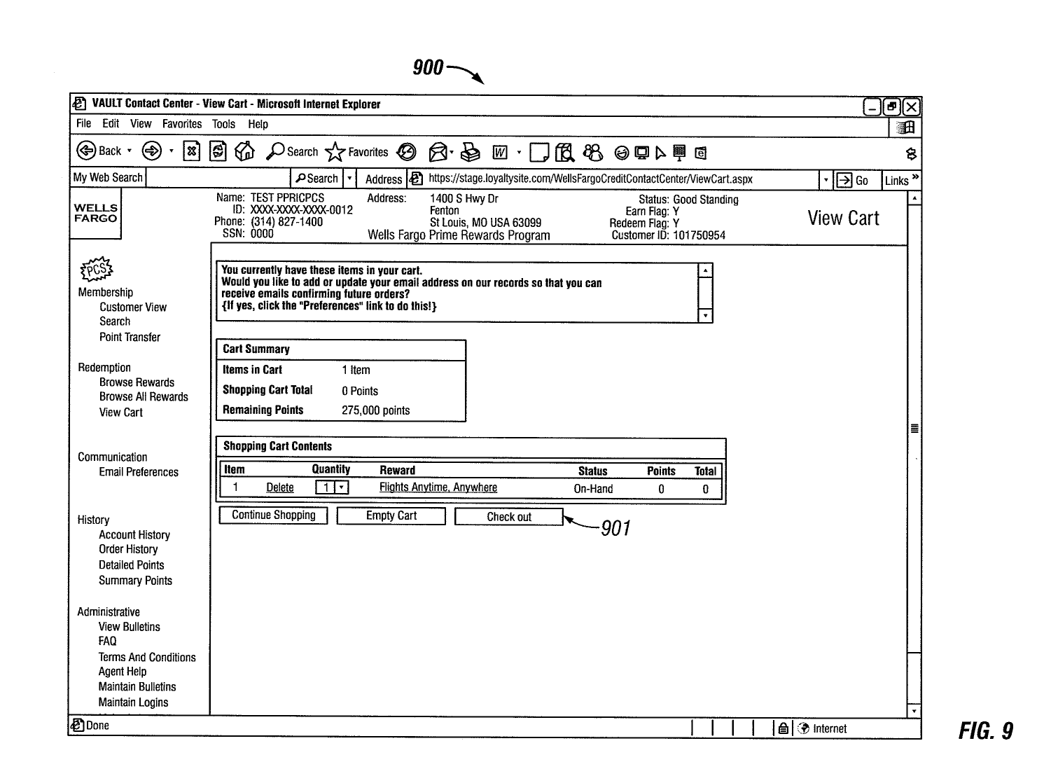

FIG. 9 provides a view of a ‘view cart’ screen 700 that allows the participant to view the item or items in the shopping cart prior to finalizing his or her purchase. A ‘Cart Summary’ 901 displays the number of items in the cart, the point total for the items in the shopping cart and the remaining points on the participant's accrued point total. A separate box 902 displays the shopping cart contents. To redeem points and check out, the participant selects the ‘Check out’ icon 903.

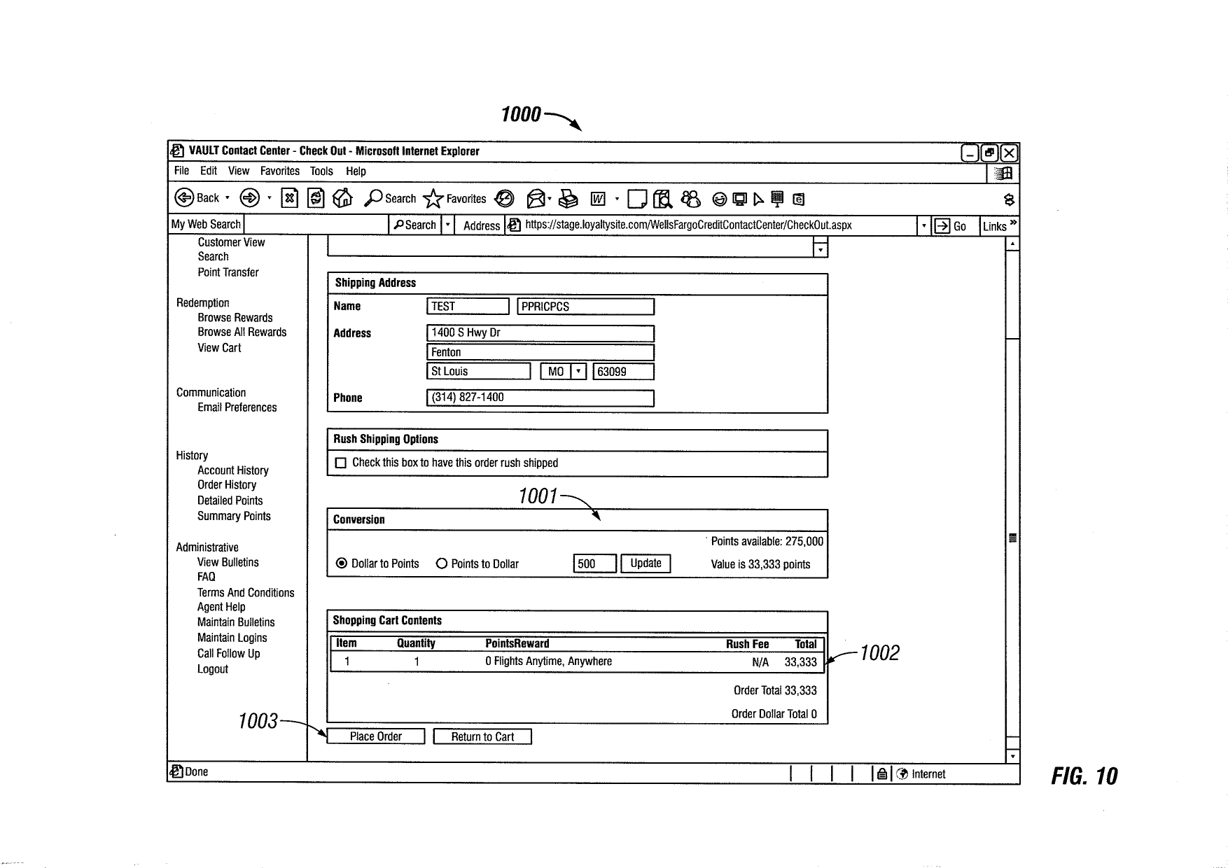

FIG. 10 provides a view of a ‘Check out’ screen 1000. A conversion feature 1001 allows the participant to view the reward value either in points or dollars, for example. The ‘Check out’ screen again displays ‘Shopping Cart Contents’ 1002. The participant places the order by selecting a ‘Place Order’ icon 1003.

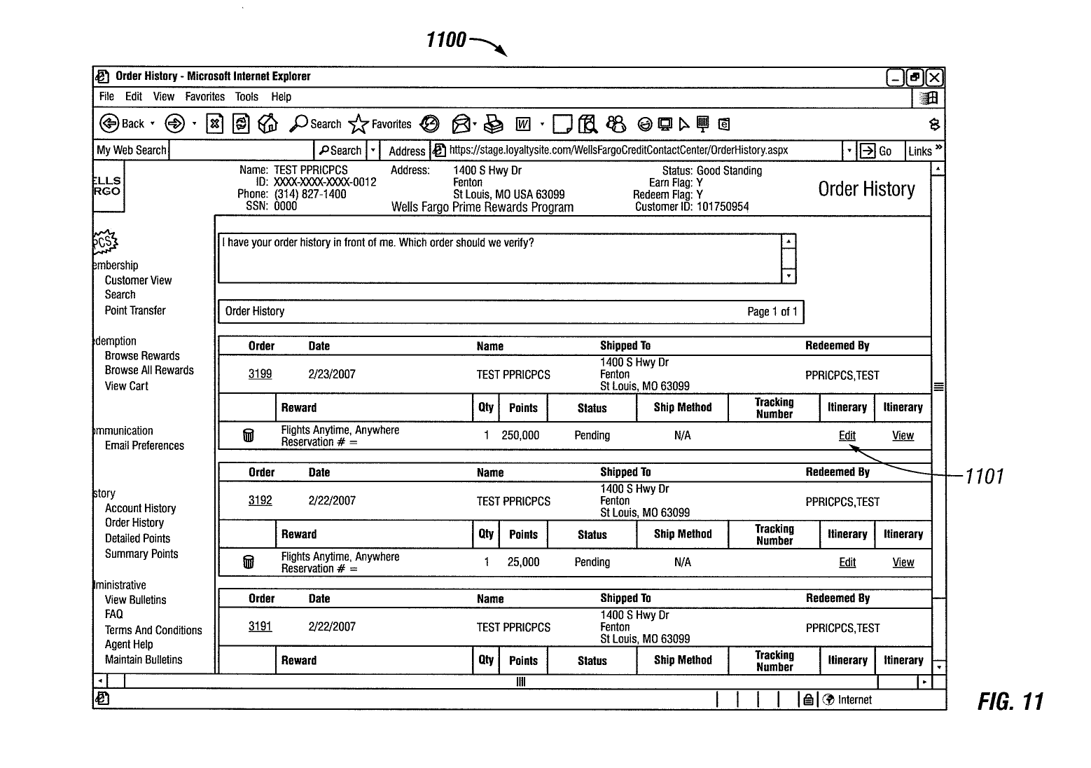

FIG. 11 provides a view of an ‘Order History’ screen 1100, showing displaying all redemption transactions associated with the participant. By selecting an ‘Edit Itinerary’ link, 1101, the participant is able to edit the itinerary. Selecting the ‘View’ link 1102 navigates the participant to e ‘My Trip and More’ screen 1200, whereupon the participant is able to view details of the itinerary by selecting a ‘View Travel Plans’ icon 1201.

The foregoing description of the user interface and the air travel redemption transaction are exemplary only and not intended to limit the invention. In fact the redemption transaction may involve more or fewer steps and operations and the steps and operations may occur in a different order than that described herein. Additionally, the features and functional capabilities of the user interface and software application may be different from that described herein. The user interface may be differently arranged, and the interface elements may be differently designated.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A computer-implemented system for a combined rewards program comprising:
means for a customer to make a request to enroll into a combined rewards program;
responsive to said request to enroll, means for identifying and additionally systematically enrolling into the program related items associated with the customer, said means for identifying and additionally automatically enrolling using a unique customer identifier;
responsive to said enrolling, means for performing fulfillment;
means for sending reward recommendations and offers to the customer; and
a variable travel rewards ordering and fulfillment program module that assigns a cash value to reward points and allows a program participant to select any desired air travel itinerary to any desired destination on any carrier substantially without restriction and to pay for the air travel with rewards points equivalent to the purchase price for a ticket for the selected itinerary as though the reward points were cash.

2. The computer-implemented system of claim 1, further comprising:
multiple system of records of card products for identifying and enrolling accounts, performing fulfillment, and sending reward recommendations and offers.

3. The computer-implemented system of claim 1, further comprising:
one or more entry points, wherein said one or more entry points are external or internal to an enterprise.

4. The computer-implemented system of claim 1, wherein said variable travel rewards ordering and fulfillment program module comprises:
means for calculating cash value of a participant's accrued rewards point total;
a user interface including means for displaying said accrued rewards point total and said calculated cash value and means for selecting an air travel itinerary;
order fulfillment means for ticketing the desired itinerary; and
order completion means for securing payment either in rewards points or in a combination of rewards points and cash.

5. Within a computer-implemented system for a combined rewards program that systematically enrolls related items associated with a customer into the program by means of a unique customer identifier, a variable travel rewards ordering and fulfillment program module comprising:
means for calculating cash value of a participant's accrued rewards point total;
a user interface including means for displaying said accrued rewards point total and said calculated cash value and means for selecting an air travel itinerary;
order fulfillment means for ticketing the selected itinerary; and
order completion means for securing payment either in rewards points or in a combination of rewards points and cash;
wherein a program participant is permitted to select any desired air travel itinerary to any desired destination on any carrier substantially without restriction and to pay for the air travel with rewards points equivalent to the purchase price for a ticket for the selected itinerary as though the reward points were cash.

6. The module of claim 5, wherein said order fulfillment means comprises a link to a travel reward fulfillment agent, wherein said agent tickets said selected itinerary by means of an automated ticketing system.

7. The module of claim 5, wherein said means for selecting an air travel itinerary comprises a link to an airfare pricing and shopping system, wherein said user interface includes interface elements for searching said third-party system, retrieving itinerary information and selecting an itinerary from the retrieved itinerary information.

8. The module of claim 5, said user interface including control elements that allow a user to convert a cash value to a points value and a points value to cash value.

9. Within a computer-implemented system for a combined rewards program that systematically enrolls related items associated with a customer into the program by means of a unique customer identifier, a user interface for selecting an air travel itinerary comprising:
at least one control element that allows a user to convert a cash value to a reward points value and a reward points value to a cash value;
means for displaying any of a point value of a reward and a cash value for said reward;
a plurality of data entry elements and control elements for interacting with an order completion module for securing payment either in rewards points or in a combination of rewards points and cash;
wherein a program participant is permitted to select any desired air travel itinerary to any desired destination on any carrier substantially without restriction and to pay for the air travel with rewards points equivalent to the purchase price for a ticket for the selected itinerary as though the reward points were cash.

10. The user interface of claim 9 further comprising:
a plurality of data entry elements and control elements for interfacing with an airfare pricing and shopping system, including elements for searching said airfare pricing and shopping system, retrieving itinerary information and selecting an itinerary from the retrieved itinerary information

11. A computer-implemented relationship rewards process, comprising the steps of:
providing a one enrollment mechanism, whereby a customer enrolls into a relationship rewards program at one entry point and systematically has one or more eligible accounts enrolled into the relationship rewards program;
for each system of record for each enrolled account, sending a periodic file feed to an enterprise system of record for tracking;
said enterprise system of record using each said periodic file feed to track points earned per product and to combine said points into a total amount of points;
said enterprise system of record sending said points per product and said total amount of points to other systems for providing a points summary to a customer;
said enterprise system of record and any of said each system of record sending files with enrollment data and points earned per product to a relationship rewards vendor for the vendor's records;
displaying and making available for redemption said total amount of points, wherein said total amount of points are also itemized;
assigning a cash value to a rewards point; and
redeeming rewards points as payment for air travel, wherein a program participant is permitted to select any desired air travel itinerary to any desired destination on any carrier substantially without restriction and to pay for the air travel with rewards points equivalent to the purchase price for a ticket for the selected itinerary as though the reward points were cash

12. The computer-implemented relationship rewards process of claim 11, wherein said displaying and making available for redemption is online, on a statement, and via a customer service representative.

13. The computer-implemented relationship rewards process of claim 11, further comprising the steps of:
calculating cash value of a point value of a reward;
displaying via a user interface said point value of said reward and said calculated cash value;
selecting an air travel itinerary;
ticketing the desired itinerary; and
securing payment either in rewards points or in a combination of rewards points and cash.

14. The computer-implemented relationship rewards process of claim 13, wherein said step of selecting an air travel itinerary comprises the steps of:
searching an airfare pricing and shopping system;
retrieving itinerary information; and
selecting an itinerary from the retrieved itinerary information

15. The computer-implemented rewards process of claim 13, wherein the step of ticketing the desired itinerary comprises the step of:
ticketing said selected itinerary by a travel reward fulfillment agent by means of an automated ticketing system.

16. The computer-implemented relationship rewards process of claim 11, further comprising the step of: matching a primary and a secondary predetermined unique number of a cardholder for enrolling credit and check cards.

17. A computer-implemented relationship rewards process, comprising the steps of:
providing a one enrollment mechanism, whereby a customer enrolls into a relationship rewards program at one entry point and systematically has one or more eligible accounts enrolled into the relationship rewards program;
for each system of record for each enrolled account, sending a periodic file feed to an enterprise system of record for tracking;
said enterprise system of record using each said periodic file feed to track points earned per product and to combine said points into a total amount of points;
said enterprise system of record sending said points per product and said total amount of points to other systems for providing a points summary to a customer;
said enterprise system of record and any of said each system of record sending files with enrollment data and points earned per product to a relationship rewards vendor for the vendor's records;
displaying and making available for redemption said total amount of points, wherein said total amount of points are also itemized;
assigning a cash value to a rewards point;
booking air travel by a program participant with a vendor of the program participant's own choice and paying for the booked air travel with the program participant's credit card; and
redeeming rewards points toward credit on a balance on the credit card incurred by paying for the booked air travel.

18. The computer-implemented relationship rewards process of claim 17, wherein said displaying and making available for redemption is online, on a statement, and via a customer service representative.

19. The computer-implemented relationship rewards process of claim 17, further comprising the steps of:
calculating cash value of a participant's accrued rewards point total;
displaying via a user interface said accrued rewards point total and said calculated cash value.

20. The computer-implemented relationship rewards process of claim 17, further comprising the step of: matching a primary and a secondary predetermined unique number of a cardholder for enrolling credit and check cards
